(19) United States
(12) Patent Application Publication
(10) Pub. No.: US 2009/0217049 A1
(43) Pub. Date: Aug. 27, 2009

(54) METHOD FOR LINKING A DIGITAL CONTENT TO A PERSON

(76) Inventor: Arndt Seehawerü, Münster (DE)

Correspondence Address: CANTOR COLBURN, LLP, 20 Church Street, 22nd Floor, Hartford, CT, 06103, US

(21) Appl. No.: 12/096,854

(22) PCT Filed: Dec. 11, 2006
(86) PCT No.: PCT/EP2006/011901

§ 371 Date: Dec. 8, 2008

(30) Foreign Application Priority Data
Dec. 10, 2005 (DE) 10 2005 059 139.6

(51) Int. Cl. H04L 9/32; G06F 17/30

(52) U.S. Cl. 713/176; 707/100; 707/E17.044

(57) ABSTRACT

A process is proposed for linking digital content specific to the person. This is marked by the following steps: generation of a on-to-one key, generation of a first data record that contains the key and data space identifying the person, implementation of the key in the digital content.

### TECHNICAL FIELD OF THE INVENTION

The present invention deals with a process for linking digital content specific to a person with a person.

### BRIEF DISCUSSION OF RELATED ART

Processes for linking digital content with a person are used in order to assign digital content, for example a data file, to a specific person at any time. With the person, we are dealing with the legal owner of the digital content. Under the concept of “person” any natural person, corporation, association or any assigned unity can be understood. For example, a person can acquire ownership of digital content in a virtual shop such as one available on the Internet. Through such a virtual shop the person can acquire personal usufruct of the digital content. Possibly it may not be permitted that the person pass on the digital content to a third party.

US 2005/0102236 A 1 shows a process for protecting digital content that is made available through a server of a provider.

### BRIEF SUMMARY OF THE INVENTION

The invention seeks to improve the linking of digital content with a person.

According to embodiments of the invention a process for linking definite digital content for a person with the person is proposed.

In particular, the following steps are designated as part of the invention:
Generation of a one-to-one key,
Generation of a first data record that contains the key and a data space identifying the person, by which the person is ascertainable with the known key over the first data record,
Implementation of the key in the digital content.

Then a one-to one key is generated. In this application “key” can be understood to be an identifier, for a databank key as an example, in which each key is found only once. With such a key, therefore, a set of n data records, contained in a databank, can be marked one-to one, in order to bring this in relation to other data. The key or the identifier can deal with every type of data, for instance text, a number and/or an alphanumerical piece of data.

Preferably the key can deal with a random number n, by which it can be assured that the respective key is one-to-one, that is not already present. From the one-to-one key and a data space that identifies the person, the first data record can be generated. A set N of such first data records can be referenced at any time by the key. It is also possible, inasmuch as the key is known, to determine the person belonging to this key by such a first data record.

Finally, the key can be implemented in the digital content. “Implementation of the key in the digital content” can be understood, for example, as the provision of the digital content with a—digital—watermark, where the watermark can be read from the digital content at any time so that the key results from it. The preparation of such a watermark with digital content is comparatively expensive and processor intensive and its expense increases with the size of the watermark. It is advantageous that only comparatively small keys be implemented in the digital content in the process designated here. This saves resources, especially in the form of computing power and/or storage space, both in the implementation of the key, in storage or re-storage of the digital content and, if the case be, in reading the key from the watermark. Nonetheless, the digital content can be assigned at any time by the key being read from the watermark and to the first data record of the person matching the key. Particularly, data related to person should not be filed in the watermark.

The implementation of data in the form of a watermark in digital content, particularly in text files, music files, video files, multimedia files or the like, is known. For instance, US 2002/0168082 shows how watermarks can be assigned when there are many inquiries in real time. The respective parts of the description as well as the description of the figures will be made herewith through reference to the contents of this application as well.

A digital watermark can have a private character, that is password protected. Further, the watermark can be created such that it is even readable from the digital content that is marked with it, thus without comparison with the respective digital content without the watermark. Such a watermark can be implemented by a discrete Fourier transformation. Then the watermark can be invisible to the greatest extent and exhibit an error correction code with a certain hamming distance. In addition, the watermark can be embedded so that it is not lost, or compromised, through normal modifications of the digital content.

The digital content provided with the key can be accessed through a virtual shop, particularly over the Internet, of the person. The virtual shop can then be available through a corresponding net work connection, for example Internet connection and a corresponding furnished shop server. The shop server can have a first data bank for storing the first data record. It is thus possible to assign this digital content to the respective buyer over the first data bank of the shop server by determining the key of digital content sold in the virtual shop.

Finally, it is possible to integrate the one-to-one key in a second data record and store this in a second data bank. The second data bank can be filled so that it contains the entire set of keys generated so far. Through the second data bank it is thus verifiable at any time whether a newly generated key was generated already or was stamped to a sold digital content as a watermark. The generation of a key can happen so that a key is first of all generated, for example in the form of a random number n. It can then be easily checked by means of the second databank whether the newly generated key already exists. In the case that a newly generated key already exists a random number will be updated or a key generated until this is actually new, that is one-to-one. The key or random number generated thus can then be shown as a new key and stored in the second data bank.

More advantageously an appropriately established registration server can be used to generate the key. It is possible then that there is a public registration server that generates the keys, put them in the second data bank and thus insures that each key is assigned only once. The registration server has the second data bank and a unit for generating keys. The registration server can be connected to the network for transmitting the key. It is then possible that the shop server queries the registration server for a key and appropriately gets it back.

It is possible that the registration server additionally inserts in the respective second data record a piece of data of which the key is queried by the shop server, that is the virtual shop. This enables a better traceability and assignment of the key used. The registration server can deal with a public server to which a multitude of shops have access.

Besides it is possible to publish the second data bank since it allows no kind of assignment to any client except the multitude of keys. Particularly for the case in which keys deal with random numbers, no conclusions, especially on any clients, number, time as well as type of digital content purchased, are possible.

In order to prevent misuse of the keys, query as well as provision of the can itself be encoded.

Embodiments of the invention further concern an arrangement with a shop server and a registration server. The servers of the arrangement are equipped to carry out a process in dialog over a network according to the independent claims.

### BRIEF DESCRIPTION OF THE DRAWING

In the following embodiments of the invention are more closely explained by means of the drawing. The only one

FIG. 1 shows an arrangement with a shop server, a registration server and a customer computer.

### DETAILED DESCRIPTION OF THE INVENTION

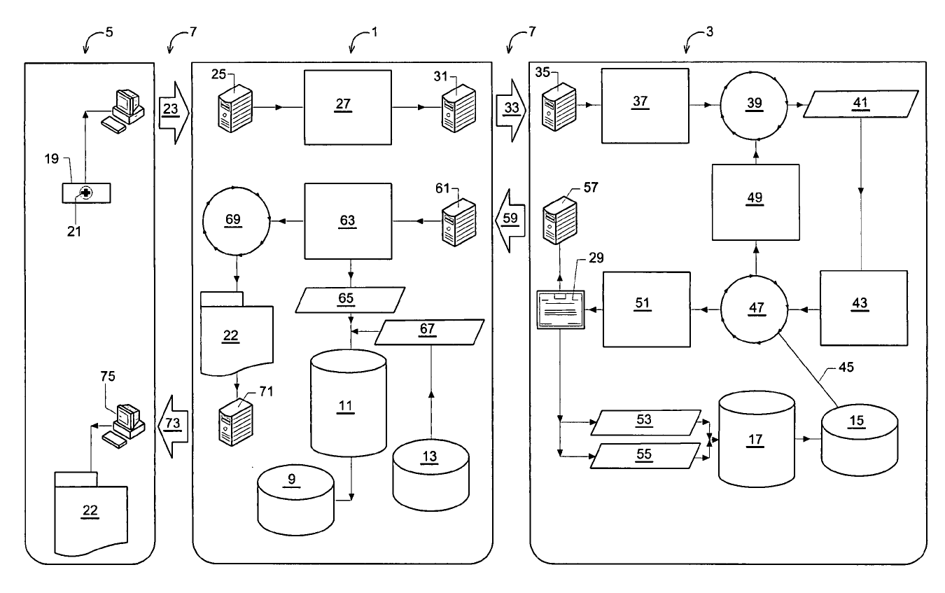

FIG. 1 shows an arrangement with a shop server 1, a registration server 3 and a customer computer 5. The shop server 1, the registration server 3 and the customer computer 5 are in dialog with each other over a network 7. The customer computer 5 can be any device capable of networking that is equipped to submit a shopping query to an appropriately equipped shop server over a network and to receive digital content from these. The customer computer 5 can be realized as a control unit, personal computer, mobile telephone, planner, mobile communications device of an automobile, shopping machine and/or the like and can have an appropriate input interface for the person as well as an output interface for the digital content.

The shop server 1 has a first data bank 9 that is equipped to store at least one first data record 11, if not a multitude of first data records 11. In addition, the shop server 1 has a third data bank 13 that is equipped to store data relating to persons, for instance customer data of a virtual shop, that is realized through the shop server 1.

The registration server 3 has a second data bank 15 in which a second data record 17, for instance a multitude of such second data records 17, can be stored.

The shop server 1, the registration server 3 and the customer computer 5, in particular the shop computer 1 and the registration server 3 of the device as represented in FIG. 1, are equipped to carry out a process for linking specific digital content for a person with this person. In order to make clear the process, the single steps in the respective components of the device are sketched in the form of a flow chart. Steps that are carried out with the help of a component of the device, for example of the shop server 1, the registration server 3, the customer computer 5, are sketched in FIG. 1 in the appropriate symbol. In the following the process will be more closely explained in relation to the flow chart represented in FIG. 1:

The process represented in FIG. 1 is triggered by a shopping decision 19 of a person 21. The customer computer 5 can have an appropriate interface for this. After the shopping decision 19 the further process runs fully automatic until the customer computer 5 receives digital content 22 concerned with the shopping decision 19. If necessary the process can start automatically. First, the customer computer 5 sends a shopping query to the shop server 1 that is symbolized by an arrow 23. Further, the arrow 23 symbolizes a part of the network 7. The network 7 can be any network, for instance a local network and/or the Internet. The shop server 1 receives the shopping query in one step 25. In a subsequent step 27 the shop server 1 generates a query according to a watermark 29 that is symbolized by a rectangle with 3 vertical lines within the registration server 3.

In a step following that the shop server 1 sends the query to the registration server 3 according to the watermark 29 that is symbolized by the arrow 33. The registration server 3 receives the query of the shop server 1 in one step 35 and the in one step 37 derives the task of generating the watermark 29. In a step 39 the registration server 3 generates a key, for instance a data bank key.

The key is preferably a random number n. After determination of the random number n, the registration server 3 puts this in a data space 41. The data space 41 is checked to determine whether the generated random number n has already been assigned. Then a query 45 of the second data bank 15 of the registration server 3 is started in step 43. In the case that the query 45 results in the second data bank 15 already having a second data record 17, that contains the random number just generated in step 39, a branching 47 of the run is decided to carry out step 39 again. Then in a step 49 the command is generated to carry out step 39 again, that is newly determine a random number n. The step 39 of registration server 3 can be executed by any random number generator, for instance one implemented in a standard language. It could be a hard-wired random number generator just as well. Finally, it is also conceivable to execute the step 39 by an appropriately installed mechanical device.

Provided the query 45 results in that the second data bank 15 does not yet contain the random number n generated in the step 39, the branching 47 flows into a step 51 where the generated random number n, that is the established watermark 29, is released. The released watermark 29 is then filed in a data space 53. Optionally, a further data space can be added to the data record 17 that contains a password of the shop. Consequently the second data record 17 contains the watermark 29 forwarded from the shop server 1 and a respective password of the forwarding virtual shop, that is set up through the shop server 1. Then, the second data record 17 is filed in the second data bank 15.

The watermark 29, thus generated and stored, is then sent in a step 57 by the registration server 3 to the shop server 1 over the network 7 which is indicated by an arrow 59. The watermark 29 sent over the network 7 is received in a step 61 by the shop server 1. The watermark 29 received is assigned to a data space 65 in a step 63. The data space 65, that contains the water mark 29, is filed together with a further data space 67 in the first data record 11. The first data record 11 is then stored in the first data bank 9. The data space 67 contains a marker that enables one-to-one identification of the person 21. This can be, for example, the name and date of birth of the customer. It can, however, also be a one-to-one allocated customer number of a customer of the virtual shop.

The third data bank 13 of the shop server 1, that represents a customer data bank, contains data that enables the shop server 1 to identify the person 21 in a one-to-one manner already upon a shopping query 23. Here various information concerning the person 21 can be queried to assure the true identity of the customer. For example, this can be a name, a bank connection of credit card number of the person. Other identification processes are possible such as password queries, digital signatures, biometric processes or the like. Proceeding from step 63 the watermark 29 is directed additionally to a routine that enables implementation of the watermark 29 in the digital content 22. Then in step 69 the watermark 29, i.e. the random number n generated as a watermark 29, is stamped to the digital content 22.

The digital content 22 provided with the watermark 29 is transferred in a step 71 over the network 7 to the customer computer 5, which is indicated by an arrow 73. The transfer over the network 7 can take place in any manner, for example in Patent Application DE 102004056336.5 of the present applicant, the content of which, especially the description of the transferal process as well as the description of figures, is given by reference for the content of this application. The following steps take place for transfer of files over a network:
find out the size of a file to transfer,
find out a maximum allowed data traffic from the size of the files and a factor X,
stopping of a file transfer if the quantity of the resulting data traffic surpasses the maximum allowed data traffic established from the size of the file and the factor X.

An additional step is planned as well:
monitoring and summing the transferred data traffic during the file transfer.

In particular, factor X is larger than 1 and less than 2.

A further solution is specified in UD 2002/0052885 A1 in the form of a P2P (person to person) network. The respective content of US 2002/0052885 A1, particularly the description of the process as well as the accompanying description of the figures is given by reference for the content of this application. With the help of the P2P approach, the network traffic of the shop server required for transfer can be clearly reduced.

Finally, the customer computer 5 receives the digital content 22 in a step 75. Parallel to the described process further processes can be carried out, especially processes for authenticating the person 21 and/or paying for the digital content 22. A correct authentication of the person 21 assures that the assignment of the watermark 29 to the digital content 22 requested by the person 21, enabled by the process, is really referenced to the person 21.

Only by a correct authentication of the person 21 is it possible to assign the person 21 to the correct watermark 29 in the first data record 11. It is then possible at any later time to read out the watermark 29 from the digital content 22 and to find out the person 21 belonging to the digital content 22 by comparison of the watermark 29 read out again with that stored in the first data bank 9. For this it is advantageous that the watermark 29 only has one random number n, relatively small and consequently easy to implement in the digital content 22 and to read out again.

By this any kind of misuse is excluded as well, since even the knowledge of the watermark 29 by someone unauthorized allows no kind of conclusion, especially on the person 21 and their behavior. In order to derive such a conclusion an appropriate query of the data bank 9 all the more necessary. It would be conceivable to make the watermark 29 of the digital content 22 freely readable thus resources in the implementation of the watermark 29 could be further eliminated. The watermark 29 in the form of a random number n as such has no kind of useful information.

1. A process for labeling specific digital content for a person comprising:
generation of a one-to-one key,
generation of a first data record that contains the key and a data space identifying the person, by which it is possible to ascertain the person through the first data record,
implementation of the key in the digital content to be read out again, by which the digital content is assignable at any time to the first data record containing the key of the person by read-out of the key.

2. The process according to claim 1 further comprising:
construction of a second data record, that at least contains the one-to-one key.

3. The process of claim 1 further comprising:
storing of the first data record in a first data bank.

4. The process according to claim 2 further comprising:
storing of a second data record in a second data bank.

5. The process according to claim 1 further comprising:
generation of the key by the following steps:
generation of a random number n,
test whether the second data bank already contains a second data record that has the random number n generated in the preceding step,
repetition of the two above-mentioned steps if a second data record exists, that contains the random number n, and
identification of the generated random number n as a newly generated key.

6. The process according to claim 1 further comprising:
making available the digital content provided by the key to the person

7. The process according to claim 1 further comprising:
making the digital content available through a virtual shop.

8. The process according to claim 7 further comprising:
request for digital content at the virtual store by the person.

9. The process according to claim 7 further:
generation of a query by a customer computer to a shop server of the virtual shop.

10. The process according to claim 9 further comprising:
request of the key by the shop server at the registration server.

11. The process according to claim 2 further comprising:
generation of the key with a registration server.

12. The process according to claim 11 further comprising:
storing of the second data record in the second data bank, by which the second data bank is assigned to the registration server.

13. The process according to claim 2 further comprising:
generation of the second data record, by which the second data record additionally contains a data space that identifies the shop server requesting the key.

14. The process according to claim 11 further comprising:
transfer of the generated key from the registration server to the requesting shop server.

15. The process according to claim 9 further comprising:
generation of the first data record by the shop server.

16. The process according to claim 9 further comprising:
implementation of the key by the shop server.

17. The process according to claim 9 further comprising:
transfer of the digital content marked with the key by the shop server to the customer computer.

18. The process according to claim 9 further comprising:
storing of the first data record in the first data bank by the shop server.

19. The process according to claim 1 further comprising:
call-in of the data space identifying the customer before generation of the first data record from a third data bank of the shop server, by which the third data bank is designed for the management of customer data.

20. The process according to claim 1 further comprising:
implementation of the key in the digital content in the form of a digital watermark.

21. The process according to claim 1 further comprising:
transfer of arising data streams, particularly of the content, the key, the requests, over a network, particularly over the Internet.

22. The process according to claim 1 further comprising:
transfer of arising data streams in encoded form.

23. Arrangement with a shop server and a registration server, equipped to carry out a process according to claim 1 in dialog over a network.

24. Arrangement according to claim 23, additionally with a customer computer, by which the customer computer and enter into dialog with the shop server over the network.

25. Shop server, equipped to carry out a process according to claim 1 in dialog over a network with an appropriately equipped registration server.

26. Registration server, equipped to carry out a process according to claim 1 in dialog over a network with an appropriately equipped shop server.
